(19) United States
(12) Patent Application Publication
(10) Pub. No.: US 2022/0171154 A1
(43) Pub. Date: Jun. 2, 2022

(54) LENS ASSEMBLY

(71) Applicant: SAMSUNG ELECTRO-MECHANICS CO., LTD., Suwon-si (KR)

(72) Inventors: Se Yeon HWANG, Suwon-si (KR); Seok Hwan KIM, Suwon-si (KR); Tae Ho YUN, Suwon-si (KR); Kyung Ho LEE, Suwon-si (KR)

(73) Assignee: SAMSUNG ELECTRO-MECHANICS CO., LTD., Suwon-si (KR)

(21) Appl. No.: 17/211,336

(22) Filed: Mar. 24, 2021

(30) Foreign Application Priority Data
Nov. 30, 2020 (KR) 10-2020-0164893

(51) Int. Cl. G02B 7/02

(52) U.S. Cl. CPC G02B 7/026; G02B 7/021

(57) ABSTRACT

A lens assembly includes: a lens barrel; a lens accommodated in the lens barrel; and a fixing member disposed on one side of the lens and configured fix the lens to the lens barrel. The fixing member has an open ring shape.

### CROSS-REFERENCE TO RELATED APPLICATIONS

This application claims the benefit under 35 U.S.C. § 119(a) of Korean Patent Application No. 10-2020-0164893 filed on Nov. 30, 2020 in the Korean Intellectual Property Office, the entire disclosure of which is incorporated herein by reference for all purposes.

### BACKGROUND

### 1. Field

The following description relates to a lens assembly, for example, to a technology for fixedly assembling lenses in a lens barrel.

### 2. Background

A camera module may include a lens barrel accommodating lenses therein. The lenses are inserted into the lens barrel to be fixed thereto. A press-fit ring may be used to fix the lenses to the lens barrel.

The press-fit ring is inserted into the lens barrel to be in contact with and to support a lens. The press-fit ring is fixed to the lens barrel to fix a lens, supported by the press-fit ring, to the lens barrel.

An adhesive is commonly used to fix the press-fit ring to the lens barrel. In this case, when an external diameter of the press-fit ring is smaller than an internal diameter of the lens barrel, the adhesive flows into an empty space to have an effect on a fixed position of the lens or flows into an optical surface of the lens to have an adverse effect on resolving power of the camera module. Therefore, the press-fit ring is assembled inside the lens barrel in a forced fitting manner, and the press-fit ring is bent to be assembled during an assembly process.

When assembly of the press-fit ring is completed, an adhesive is applied and cured to fix the press-fit ring to the lens barrel. In this case, a fixed position of the press-fit ring may be changed by elastic force of the press-fit ring during a process of applying and curing the adhesive.

Accordingly, a structure for more stably fixing the press-fit ring to the lens barrel is desired.

The above information is presented as background information only, to assist in gaining an understanding of the present disclosure. No determination has been made, and no assertion is made, as to whether any of the above might be applicable as prior art with regard to the disclosure.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a lens assembly includes: a lens barrel; a lens accommodated in the lens barrel; and a fixing member disposed on one side of the lens and configured fix the lens to the lens barrel. The fixing member has an open ring shape.

The lens barrel may have a groove in which at least a portion of the fixing member is accommodated.

The lens groove may be disposed in an internal side surface of the lens barrel and extend in a circumferential direction.

The fixing member may be configured such that an external diameter of the fixing member increases or decreases as a distance between ends of the fixing member increases or decreases, respectively.

The fixing member may be configured to be accommodated in a groove of the lens barrel while being widened.

The fixing member may be a snap ring.

The fixing member may include holes disposed in two ends thereof, respectively.

The lens may include first and second arc portions opposing each other, and a straight portion extending from ends of the first arc portion to the second arc portion. The fixing member may be open in a position corresponding to the straight portion.

In another general aspect, a lens assembly includes: a lens barrel; and a lens accommodated in the lens barrel. The lens includes a fastening portion disposed on a side surface of the lens. The lens barrel includes a seating portion corresponding to the fastening portion. The seating portion supports the lens in a first direction parallel to an optical axis of the lens assembly when the lens is accommodated in the seating portion. The fastening portion includes a portion having a diameter increasing and then decreasing along the first direction.

The fastening portion may include a first tapered portion having a diameter increasing along the first direction, and a second tapered portion extending from the first tapered portion and having a diameter decreasing along the first direction.

The seating portion may include a tapered portion corresponding to the first tapered portion and the second tapered portion.

The fastening portion may include a convex portion on a side surface of the lens. The seating portion may include a concave portion corresponding to the convex portion.

In another general aspect, a lens assembly includes: a lens barrel including an inner surface and a plurality of grooves disposed spaced apart from each other along a circumference of the inner surface; a lens accommodated in the lens barrel; and a ring-shaped fixing member disposed on the lens, and including a plurality of projections disposed spaced apart from each other along a circumference of the ring-shaped fixing member and accommodated in the plurality of grooves, respectively. The ring-shaped fixing member is configured to limit movement of the lens in a direction parallel to an optical axis of the lens module.

The lens may arc-shaped sides and straight sides extending between the arc-shaped sides. The plurality of projections may be disposed in positions corresponding to the arc-shaped sides.

The plurality of grooves may include at least four grooves, and the plurality of projections may include at least four projections.

The ring-shaped fixing member may be secured in the lens barrel by a press fit.

Other features and aspects will be apparent from the following detailed description, the drawings, and the claims.

### BRIEF DESCRIPTION OF DRAWINGS

FIG. 1 is a perspective view of a lens assembly, according to an example.

FIG. 2 is an exploded perspective view of the lens assembly of FIG. 1.

FIG. 3 is a cross-sectional view taken along line I-I′ of FIG. 1.

FIG. 4 is a perspective view of a lens assembly, according to another example.

FIG. 5 is an exploded perspective view of the lens assembly of FIG. 4.

FIG. 6 is a cross-sectional view taken along line II-II′ of FIG. 4.

FIG. 7 is a perspective view of a lens assembly, according to another example.

FIG. 8 is an exploded perspective view of a lens assembly of FIG. 7.

FIG. 9 is a cross-sectional view taken along line III-III′ of FIG. 7.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure. Hereinafter, while embodiments of the present disclosure will be described in detail with reference to the accompanying drawings, it is noted that examples are not limited to the same.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. As used herein “portion” of an element may include the whole element or less than the whole element.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may be also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various ways as will be apparent after an understanding of this disclosure. Further, although the examples described herein have a variety of configurations, other configurations are possible as will be apparent after an understanding of this disclosure.

Herein, it is noted that use of the term “may” with respect to an example, for example, as to what an example may include or implement, means that at least one example exists in which such a feature is included or implemented while all examples are not limited thereto.

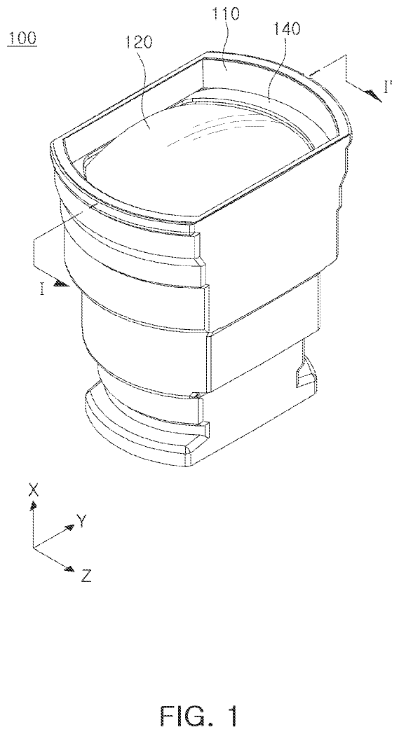

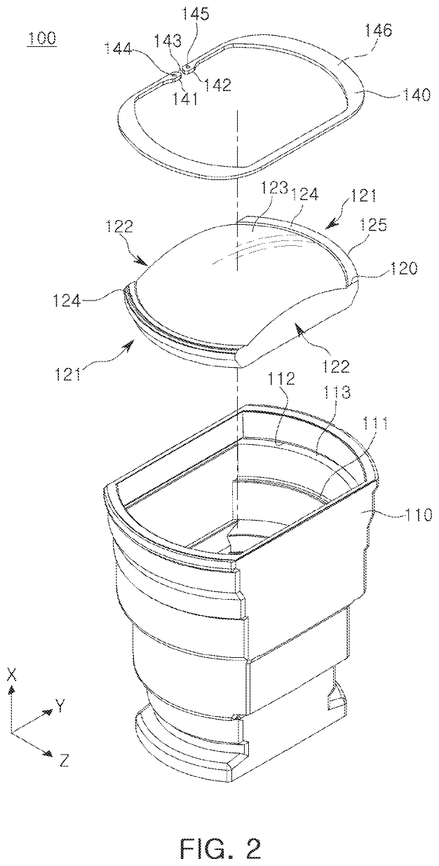

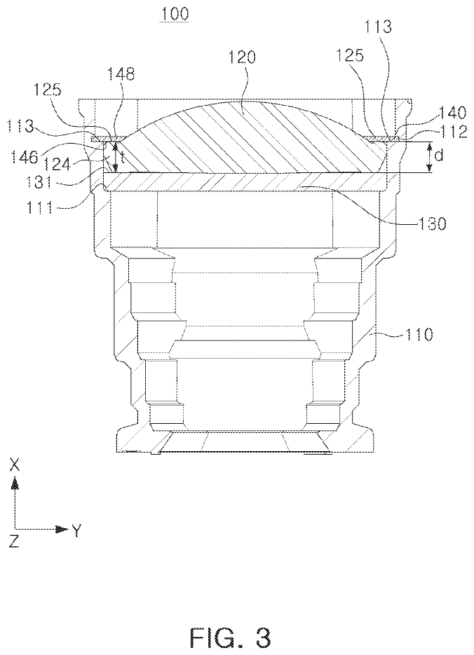

FIG. 1 is a perspective view of a lens assembly 100 according to a first example. FIG. 2 is an exploded perspective view of the lens assembly 100 of FIG. 1. FIG. 3 is a cross-sectional view taken along line I-I′ of FIG. 1. Hereinafter, the lens assembly 100 with reference to FIGS. 1 to 3.

Referring to FIGS. 1 to 3, in an example, the lens assembly 100 may include a lens barrel 110, a lens 120, and a fixing member 140. The lens 120 may be accommodated in the lens barrel 110, and the fixing member 140 may be configured to prevent the lens 120 from being removed from the lens barrel 110.

The lens barrel 110 may have an overall cylindrical shape or a columnar shape in which both sides of a cylinder are cut to be flat in one direction (for example, a Z direction). The lens 120 may be a D-cut lens 120 having a shape in which opposing sides of a circle are cut. For example, the lens 120 may include an arc portion 121 and a straight portion 122 extending parallel to an opposite corresponding arc portion 121 on both ends of the arc portion 121. For example, the arc portions are portions in which side surfaces of the lens 120 are convex, and the straight portions 122 are portions in which side surfaces of the lens 120 are flat. In the illustrated embodiment, only one lens 120 is illustrated as being provided in the lens barrel 110, but this is merely an example for ease of description, and one or more other optical elements (for example, another lens, a light blocking member, and/or a spacer) may be provided in the lens barrel 110. When the optical element is a light blocking member or a spacer, the optical element may have an incident hole configured to allow light, passing through the lens 120, to pass through the optical element from one side to the other side.

In an example, the lens 120 may include an optical portion 123, exhibiting optical performance, and a flange portion 124 extending from the optical portion 123 in a radial direction. The lens 120 may be mounted on the lens barrel 110 or another optical element 130 by the flange portion 124.

The lens barrel 110 may include a stepped portion 111 on which the lens 120 or the optical element 130 may be seated. For example, the flange portion 124 of the lens 120 may be seated on the stepped portion 111 to assemble the lens 120 in the lens barrel 110. As another example, when the optical element 130 is a lens, the flange portion of the optical element 130 may be seated on the stepped portion 111, and the flange portion 124 of the lens 120 may be seated on a flange portion of the optical element.

When the lens 120 is seated on the stepped portion 111 of the lens barrel 110 or on the optical lens 130, the movement of the lens 120 is limited in one direction. For example, when the lens 120 is seated on the optical element 130, the optical element 130 supports the lens 120 in a positive X direction, and the lens 120 cannot move further in a negative X direction. In this case, the fixing member 140 may be disposed on the lens barrel 110 to limit the movement of the lens 120 in an opposite direction (for example, the positive X direction).

In an example, the fixing member 140 may be provided on one side of the lens 120 to prevent the lens 120 from being removed from the lens barrel 110. The lens 120 may be inserted into the lens barrel 110 in the negative X direction, and then, the fixing member 140 may be coupled to the lens barrel 110 to be disposed on the lens 120. Thus, the lens 120 may be prevented from being removed from the barrel 110 in the positive X direction.

In an example, the fixing member 140 may be fixedly coupled to the lens barrel 110. A portion of the fixing member 140 may be accommodated in a groove 112, formed in an internal side of the lens barrel 110, to assemble the fixing member 140 in the lens barrel 110. For example, the groove 112 may be formed on an internal surface of the lens barrel 110 in a circumferential direction, and an edge of the fixing member 140 may be accommodated in the groove 112.

In an example, when the fixing member 140 is assembled on the lens 120, the fixing member 140 may have a shape surrounding a periphery of the optical portion 123 of the lens 120. In one example, the fixing member 140 may have a shape, similar to a shape of the lens 120. For example, an external edge of the fixing member 140 may have a shape in which opposing sides of a circle are cut to be straight.

In an example, the fixing member 140 may have an open ring shape, and may be formed in such a manner that a first end and a second end 141 and 142 of the fixing member 140 face each other with an opening 143 interposed therebetween. For example, the fixing member 140 may be a snap ring. The opening 143 of the fixing member 140 may be provided in a position corresponding to the straight portion 122 of the lens 120.

The fixing member 140 may be shrunk (e.g., narrowed) or expanded (e.g., widened) as a gap between the first and second ends 141 and 142 of the fixing member 140 is decreased or increased, respectively. For example, when a distance between the first and second ends 141 and 142 (e.g., a distance length of the opening 143 between the first and second ends 141 and 142) is decreased, an external diameter of the fixing member 140 may be decreased. When the distance between the first and second ends 141 and 142 is increased, the external diameter of the fixing member 140 may be increased. The fixing member 140 may be formed of a material having elasticity, such that the fixing member may be expanded again when external force shrinking the fixing member 140 is released. For example, the distance between a first hole 144 and a second hole 145, respectively provided in both ends 141 and 142 of the fixing member 140, may be decreased using a tool.

In an example, an internal diameter of the grove 112 in front of the lens barrel 110 (in the positive X direction) may be smaller than an external diameter of the fixing member 140. When force shrinking the fixing member 140 is released after the fixing member 140 is shrunk and placed in a position corresponding to the groove 112 of the lens barrel 110, the fixing member 140 may be expanded again to be accommodated in the groove 112 of the lens barrel 110. After the fixing member 140 is accommodated in the groove 112, the fixing member 140 may be accommodated in the groove 112 to be fixed in the optical axis direction (for example, the X direction) unless the fixing member 140 is shrunk again by a tool. For example, the fixing member 140 may be secured in the groove 112 by a press fit. Accordingly, the lens 120 may be fixedly accommodated in the lens barrel 110.

When the lens 120 is primarily seated on the lens barrel 110 (for example, when the lens 120 is assembled in the negative X direction), an upper surface 125 of the flange portion 124 of the lens 120 may be provided to correspond to (e.g., be coplanar with) a wall surface 113 of one side of the groove 112. When the fixing member 140 is accommodated in the groove 112, a distance d between a lower surface 146 of the fixing member 140 and an upper surface 131 of the optical element 130 may be the same or substantially the same as a thickness t of the flange portion 124 of the lens 120 disposed between the fixing member 140 and the optical element 130.

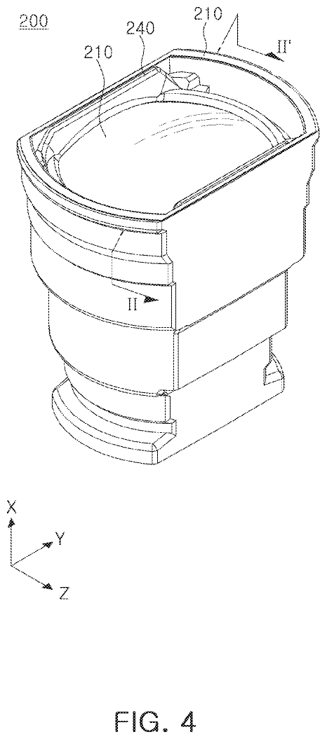

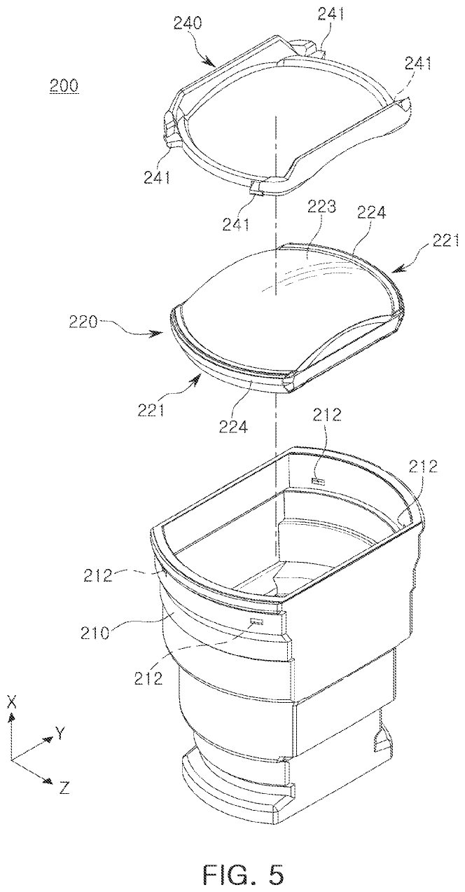

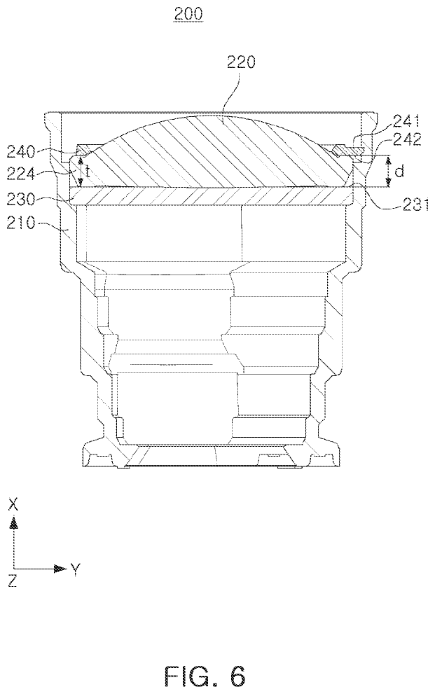

FIG. 4 is a perspective view of a lens assembly 200, according to another example. FIG. 5 is an exploded perspective view of the lens assembly 200 of FIG. 4. FIG. 6 is a cross-sectional view taken along line II-II′ of FIG. 4. Hereinafter, the lens assembly 200 will be described with reference to FIGS. 4 to 6.

Referring to FIGS. 4 to 6, in an example, the lens assembly 200 may include a lens barrel 210, a lens 220, and a fixing member 240. Duplicate descriptions of features of the lens barrel 210 and the lens 220 that are common to those of FIGS. 1 to 3 will be omitted.

In an example, the fixing member 240 may be disposed on one side of the lens 220 to prevent the lens 220 from being removed from the lens barrel 210. For example, the lens 220 may be inserted into the lens barrel 210 in a negative X direction, and then, the fixing member 240 may be coupled to the lens barrel 210 to be disposed on the lens 220. Thus, the lens 220 may be prevented from being removed from the lens barrel 210 in a positive X direction.

In an example, the fixing member 240 may be fixedly coupled to the lens barrel 210. A portion of the fixing member 240 may be accommodated in a groove 212, formed in an internal side of the lens barrel 210, to assemble the fixing member 240 in the lens barrel 210. For example, the fixing member 240 may be secured in the groove 212 by a press fit.

In an example, when the fixing member 240 is assembled on the lens 220, the fixing member 240 may have a shape surrounding a periphery of an optical portion 223 of the lens 220. In an example, the fixing member 240 may include a projection 241 extending in a radial direction. The lens barrel 210 may have a groove 212 provided to receive the projection 241. A plurality of projections 241 may be provided in various positions of an external surface of the fixing member 240, respectively, and may be spaced apart from each other along a circumference of the fixing member 240. A plurality of grooves 212 may respectively correspond to the plurality of projections 241, and may be spaced apart from each other along an inner circumference of the lens barrel 210. In the illustrated example, four projections 241 are provided in positions corresponding to arc portions 221 of the lens 220 and four grooves 212 are disposed on the internal surface of the lens barrel 210 in positions corresponding to the positions of the four projections 241, respectively. However, this is only an example. In other examples, the number or positions of the projections 241 may be different.

When the fixing member 240 is accommodated in the groove 212, a distance between a lower surface 242 of the fixing member 240 and an upper surface 231 of an optical element 230 may correspond to or substantially correspond to the thickness t of a flange portion 224 of the lens 220 disposed between the fixing member 240 and the optical element 230.

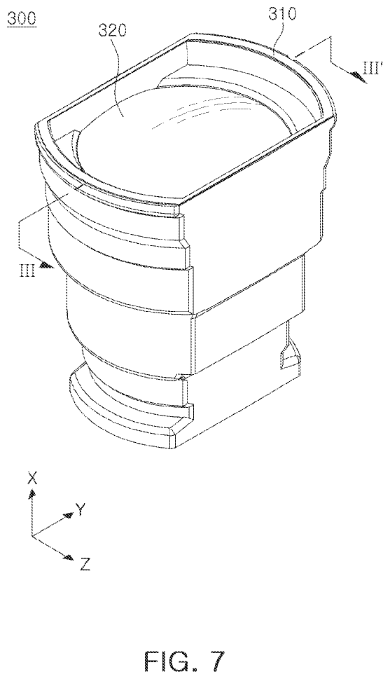

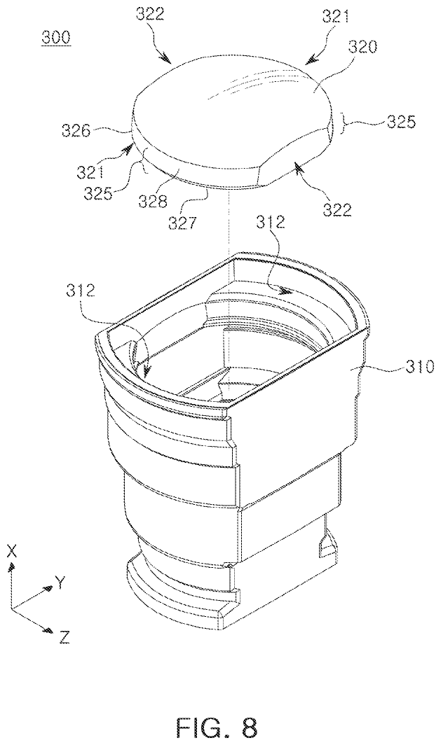

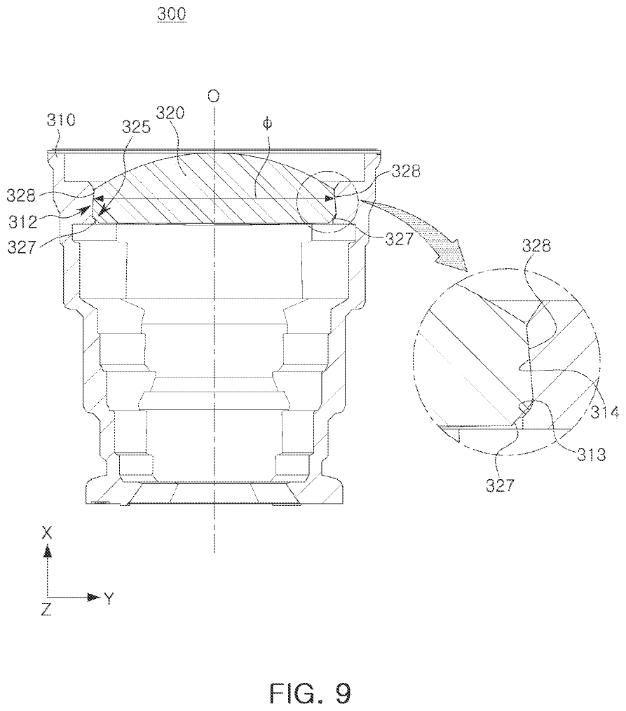

FIG. 7 is a perspective view of a lens assembly 300, according to another example. FIG. 8 is an exploded perspective view of the lens assembly 300 of FIG. 7. FIG. 9 is a cross-sectional view taken along line III-III′ of FIG. 7. Hereinafter, the lens assembly 300 will be described with reference to FIGS. 7 to 9.

Referring to FIGS. 7 to 9, in an example, the lens assembly 300 may include a lens barrel 310 and a lens 320 fixedly accommodated in the lens barrel 310. Duplicate descriptions of features of the lens barrel 310 and the lens 320 that are common to those of FIGS. 1 to 3 will be omitted.

In the lens assembly 300, the lens 320 may be fixed to the lens barrel 310 by a structure of the lens 320 itself, unlike the examples described with reference to FIGS. 1 to 6. However, in examples to be described below, the lens assembly 300 may additionally include the fixing member 140 or 240, described in FIGS. 1 to 6, on the lens 320.

In an example, the lens 320 may include a fastening portion 325 on a side thereof. The lens barrel 310 may include a seating portion 312 accommodating the fastening portion 325 of the lens 320. The fastening portion 325 and the seating portion 312 may be provided to fix the lens 320 with respect to the lens barrel 310 in an optical axis direction. For example, the lens 320 may be secured in the seating portion 312 by a press fit. In this disclosure, the phrase “fixed in an optical axis direction” refers to a state in which the lens 320 is fixed to the lens barrel 310 and does not move in a first direction (for example, a negative X direction), parallel to an optical axis, and a second direction (for example, a positive X direction), opposite to the first direction.

In an example, the fastening portion 325 may be formed by including a portion in which a diameter φ of a side surface 326 of the lens 320 is increased and then decreased along one direction (for example, the positive X direction or the negative X direction), parallel to the optical axis. In this case, an internal diameter of the seating portion 312 may also be formed to be equivalent to an internal diameter of the fastening portion 325. For example, the seating portion 312 may include a portion having an internal diameter increased and then decreased along one direction, parallel to the optical axis.

In the disclosure herein, a diameter or an internal diameter may be a parameter indicating how far a point on the side surface 326 of the lens 320 or the internal surface of the lens barrel 310 is away from a central axis O (FIG. 9). For example, the sentence “the diameter φ of the side surface 326 of the lens 320 is increased and then decreased” means that a distance from the central axis O of the lens 320 to the side surface 326 is increased and then decreased along a direction, parallel to the central axis O.

In an example, the fastening portion 325 of the lens 320 may include a first tapered portion 327, widened along the positive X direction, and a second tapered portion 327 extending from the first tapered portion 327 and narrowed along the positive X direction. In an example, a portion extending from the first tapered portion 327 to the second tapered portion 328 may be provided to have a discontinuously varying slope. In another example, a portion continuing from the first tapered portion 327 to the second tapered portion 328 may be provided as a curved surface. For example, the fastening portion 325 of the lens 320 may have a convex shape when viewed from the lens barrel 310.

In an example, the fastening portion 325 may include a convex portion on the side surface 326 of the lens 320, and the seating portion 312 may include a concave portion corresponding to the convex portion.

In an example, the seating portion 312 of the lens barrel 310 may include a third tapered portion 313, corresponding to the first tapered portion 327, and a fourth tapered portion 314 corresponding to the second tapered portion 328. For example, a diameter of the seating portion 312 may be increased in the third tapered portion 313 along the positive X direction, and may be then decreased in the fourth tapered portion 314 along the positive X direction. When the lens 320 is accommodated in the seating portion 312 of the lens barrel 310, the third tapered portion 313 of the seating portion 312 may be in close contact with the first tapered portion 327 of the lens 320 to limit the movement of the lens 320 in the negative X direction. The fourth tapered portion 314 of the seating portion 312 may be in close contact with the third tapered portion 313 of the lens 320 to limit the movement of the lens 320 in the positive X direction. Accordingly, the lens 320 may be fixed to the lens barrel 310 in the optical axis direction.

In one example, the fastening portion 325 of the lens 320 may be provided on an arc portion 321 of the lens 320. Additionally or alternatively, the fastening portion 325 of the lens 320 may be provided on a straight portion 322 of the lens 320.

In another example, the fastening portion 325 may be formed by including a portion in which a diameter of a side surface 326 of the lens 320 decreases and then increases along one direction (for example, the positive X direction or the negative X direction), parallel to the optical axis. For example, the side surface 326 of the lens 320 may include a portion in which a distance to the central axis O of the lens 320 is decreased and then increased along a direction parallel to the central axis O. In this case, an internal diameter of the seating portion 312 may also be changed to be equivalent to the fastening portion 325. For example, the seating portion 312 may include a portion having an internal diameter decreased and then increased along one direction, parallel to the optical axis.

For example, the side surface 326 of the lens 320 may include a first tapered portion, narrowed along the positive X direction, and a second tapered portion extending from the first tapered portion and widened along the positive X direction. In this case, a portion continuing from the first tapered portion to the second tapered portion may be provided as a curved surface. The seating portion 312 of the lens barrel 310 may include a third tapered portion, corresponding to the first tapered portion, and a fourth tapered portion corresponding to the second tapered portion. For example, a diameter of the seating portion 312 may be decreased in the third tapered portion along the positive X direction, and may be then increased in the fourth tapered portion along the positive X direction.

In the illustrated example, the diameter of the fastening portion 325 of the lens 320 may be gradually increased or decreased along one direction, but this is only an example. The diameter of the fastening portion 325 may be discontinuously increased or decreased. For example, the fastening portion 325 may include a portion stepped along the optical axis direction. In this case, the seating portion 312 may also have a stepped portion corresponding to the stepped portion of the fastening portion 325.

In another example, the fastening portion 325 of the lens 320 may include at least one projection extending from the side surface 326 of the lens 320 in a radial direction. In this case, the seating portion 312 of the lens barrel 310 may have a groove in which at least one projection is accommodated. In another example, the fastening portion 325 of the lens 320 may include a recessed portion recessed around the side surface 326 of the lens 320. In this case, the seating portion 312 of the lens barrel 310 may include a projection formed to be accommodated in the recessed portion.

As described above, in a lens module according to examples, a press-fit ring supporting a lens may be stably fixed to a lens barrel. In addition, manufacturing processes and manufacturing costs may be reduced.

While specific examples have been illustrated and described above, it will be apparent after gaining an understanding of this disclosure that various changes in form and details may be made in these examples without departing from the spirit and scope of the claims and their equivalents. The examples described herein are to be considered in a descriptive sense only, and are not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens assembly, comprising:
a lens barrel;
a lens accommodated in the lens barrel; and
a fixing member disposed on one side of the lens and configured fix the lens to the lens barrel,
wherein the fixing member has an open ring shape.

2. The lens assembly of claim 1, wherein the lens barrel has a groove in which at least a portion of the fixing member is accommodated.

3. The lens assembly of claim 2, wherein the groove is disposed in an internal side surface of the lens barrel and extends in a circumferential direction.

4. The lens assembly of claim 1, wherein the fixing member is configured such that an external diameter of the fixing member increases or decreases as a distance between ends of the fixing member increases or decreases, respectively.

5. The lens assembly of claim 1, wherein the fixing member configured to be accommodated in a groove of the lens barrel while being widened.

6. The lens assembly of claim 1, wherein the fixing member comprises a snap ring.

7. The lens assembly of claim 1, wherein the fixing member includes holes in two ends thereof, respectively.

8. The lens assembly of claim 1, wherein the lens comprises first and second arc portions opposing each other, and a straight portion extending from ends of the first arc portion to the second arc portion, and
wherein the fixing member is open in a position corresponding to the straight portion.

9. A lens assembly, comprising:
a lens barrel; and
a lens accommodated in the lens barrel,
wherein the lens comprises a fastening portion provided on a side surface of the lens, and the lens barrel comprises a seating portion corresponding to the fastening portion,
wherein the seating portion supports the lens in a first direction parallel to an optical axis of the lens assembly when the lens is accommodated in the seating portion, and
wherein the fastening portion comprises a portion having a diameter increasing and then decreasing along the first direction.

10. The lens assembly of claim 9, wherein the fastening portion comprises a first tapered portion having a diameter increasing along the first direction, and a second tapered portion extending from the first tapered portion and having a diameter decreasing along the first direction.

11. The lens assembly of claim 10, wherein the seating portion comprises a tapered portion corresponding to the first tapered portion and the second tapered portion.

12. The lens assembly of claim 9, wherein the fastening portion comprises a convex portion on a side surface of the lens, and the seating portion comprises a concave portion corresponding to the convex portion.

13. A lens assembly, comprising:
a lens barrel including an inner surface and a plurality of grooves disposed spaced apart from each other along a circumference of the inner surface;
a lens accommodated in the lens barrel; and
a ring-shaped fixing member disposed on the lens, and including a plurality of projections disposed spaced apart from each other along a circumference of the ring-shaped fixing member and accommodated in the plurality of grooves, respectively,
wherein the ring-shaped fixing member is configured to limit movement of the lens in a direction parallel to an optical axis of the lens module.

14. The lens assembly of claim 13, wherein the lens includes arc-shaped sides and straight sides extending between the arc-shaped sides, and
wherein the plurality of projections are disposed in positions corresponding to the arc-shaped sides.

15. The lens assembly of claim 14, wherein the plurality of grooves comprise at least four grooves, and the plurality of projections comprise at least four projections.

16. The lens assembly of claim 13, wherein the ring-shaped fixing member is secured in the lens barrel by a press fit.
